(19) United States
(12) Patent Application Publication
(10) Pub. No.: US 2019/0259198 A1
(43) Pub. Date: Aug. 22, 2019

(54) SYSTEMS AND METHODS FOR GENERATING VISUAL REPRESENTATIONS OF A VIRTUAL OBJECT FOR DISPLAY BY USER DEVICES

(71) Applicant: Tsunami VR, Inc., Del Mar, CA (US)

(72) Inventors: Anthony DUCA, Carlsbad, CA (US); David ROSS, San Diego, CA (US)

(21) Appl. No.: 16/281,980

(22) Filed: Feb. 21, 2019

Related U.S. Application Data
(60) Provisional application No. 62/633,579, filed on Feb. 21, 2018.
(60) Provisional application No. 62/633,581, filed on Feb. 21, 2018.
(60) Provisional application No. 62/638,567, filed on Mar. 5, 2018.

(51) Int. Cl. G06T 15/20; G06F 3/14

(52) U.S. Cl. CPC G06T 15/20; G06F 3/14

(57) ABSTRACT

Systems, methods, and computer-readable media for operating a virtual environment provided by a mixed reality platform are provided. The method can include receiving first position and orientation information from a first user device based on a first position and orientation of the first user device. The method can include importing data related to a first virtual object from the virtual environment based on the first position and orientation information. The method can include rendering the first virtual object as a rendered object relative to the first position and orientation. The method can include generating a two dimensional representation of the rendered object. The method can include transmitting the two dimensional representation to the first user device. The method can include causing a user device to display the generated visual representation.

### CROSS REFERENCE TO RELATED APPLICATIONS

This application claims priority to U.S. Provisional Patent Application Ser. No. 62/633,579, filed Feb. 21, 2018, entitled “SYSTEMS AND METHODS FOR GENERATING VISUAL REPRESENTATIONS OF A VIRTUAL OBJECT FOR DISPLAY BY USER DEVICES,” U.S. Provisional Patent Application Ser. No. 62/633,581, filed Feb. 21, 2018, entitled “SYSTEMS AND METHODS FOR GENERATING DIFFERENT LIGHTING DATA FOR A VIRTUAL OBJECT,” and to U.S. Provisional Patent Application Ser. No. 62/638,567, filed Mar. 5, 2018, entitled “SYSTEMS AND METHODS FOR GENERATING OR SELECTING DIFFERENT LIGHTING DATA FOR A VIRTUAL OBJECT,” the contents of which are hereby incorporated by reference in their entirety.

### BACKGROUND

### Technical Field

This disclosure relates to virtual reality (VR), augmented reality (AR), and mixed reality (MR) technologies.

### Related Art

Mixed reality (MR), sometimes referred to as hybrid reality, is the term commonly applied to the merging of real or physical world and virtual worlds to produce new environments and visualizations where physical and digital objects co-exist and interact. Mixed reality visualizations and environments can exists in the physical world, the virtual world, and can include a mix of reality, virtual reality (VR), and augmented reality (AR) via immersive technology including interactive environments and interactive three-dimensional (3D) virtual objects. Users of MR visualizations and environments can move around the MR visualizations and interact with virtual objects within the virtual environment.

Interactive 3D virtual objects can be complex and contain large amounts of information that describe different features of the virtual objects, including the geometry, appearance, scenery, and animation of the virtual objects. Particular features of a virtual object may include shape, surface geometry, color, texture, material type, light sources, cameras, peripheral objects, animation, physical properties, and kinematics.

MR, VR, and AR (or similar) devices can provide complex features and high-fidelity of representations of a physical world that can be useful in instruction or various types of training curricula or programs.

### SUMMARY

An aspect of the disclosure provides a method for operating a virtual environment provided by a mixed reality platform. The method can include receiving, at the platform, first position and orientation information from a first user device based on a first position and orientation of the first user device. The method can include importing, at the platform, data related to a first virtual object from the virtual environment based on the first position and orientation information. The method can include rendering the first virtual object as a rendered object relative to the first position and orientation. The method can include generating a two dimensional representation of the rendered object. The method can include transmitting the two dimensional representation to the first user device. The method can include causing a user device to display the generated visual representation.

The method can include receiving second position and orientation information from the first user device indicating a second position and orientation of the first user device.

The method can include rendering the first virtual object relative to the second position and orientation. The method can include generating a second two dimensional representation of the rendered object based on the second position and orientation. The method can include transmitting the second two dimensional representation to the first user device.

The method can include generating a visual representation of the rendered object relative to a new field of view from each of one or more possible combinations of position and orientation to which the user can move from the first position and orientation.

The method can include transmitting visual representations associated with the one or more possible combinations of position and orientation. The method can include causing the user device to display the visual representations generated for a possible position and orientation that matches a second position and orientation different from the first position and orientation.

The generating can include generating the two dimensional representation of portions of the rendered virtual object that user would see relative to a field of view of that user.

The two dimensional representation of the rendered object comprises a point cloud or a two dimensional image of the rendered object.

Another aspect of the disclosure provides a non-transitory computer-readable medium for operating a virtual environment provided by a mixed reality platform. The non-transitory computer-readable medium can have instructions that when executed by one or more processors, cause the one or more processors to receive first position and orientation information from a first user device based on a first position and orientation of the first user device. The instructions can further cause the one or more processors to import data related to a first virtual object from the virtual environment based on the first position and orientation information. The instructions can further cause the one or more processors to render the first virtual object as a rendered object relative to the first position and orientation. The instructions can further cause the one or more processors to generate a two dimensional representation of the rendered object. The instructions can further cause the one or more processors to transmit the two dimensional representation to the first user device. The instructions can further cause the one or more processors to cause a user device to display the generated visual representation.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of system for creating computer-generated virtual environments and providing the virtual environments as an immersive experience for VR, AR and/or MR users;

FIG. 1B is a functional block diagram of user device for use with the system of FIG. 1;

FIG. 2A is a flowchart of an embodiment of a process for generating visual representations of a virtual object, and transmitting different visual representations to different user devices for display of those visual representations by the user devices using the system of FIG. 1A and FIG. 1B;

FIG. 2B is a flowchart of another embodiment of a process for generating visual representations of a virtual object from possible positions and orientations to which a user may move, and transmitting the visual representations to a user device operated by that user for later use by the user device depending on where the user actually moves using the system of FIG. 1A and FIG. 1B; and

FIG. 3 is a flowchart of an implementation of the flowchart of FIG. 2A.

### DETAILED DESCRIPTION

This disclosure relates to different approaches for using a virtual reality (VR) device to emulate user experience of an augmented reality (AR) device.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics of each of the described embodiments may be combined in any suitable manner in one or more embodiments.

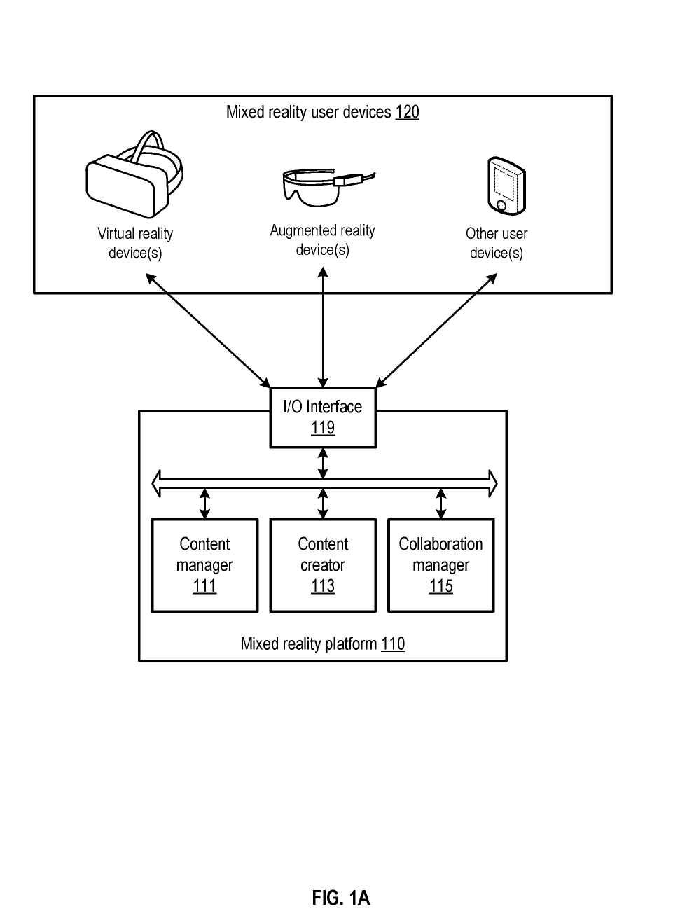

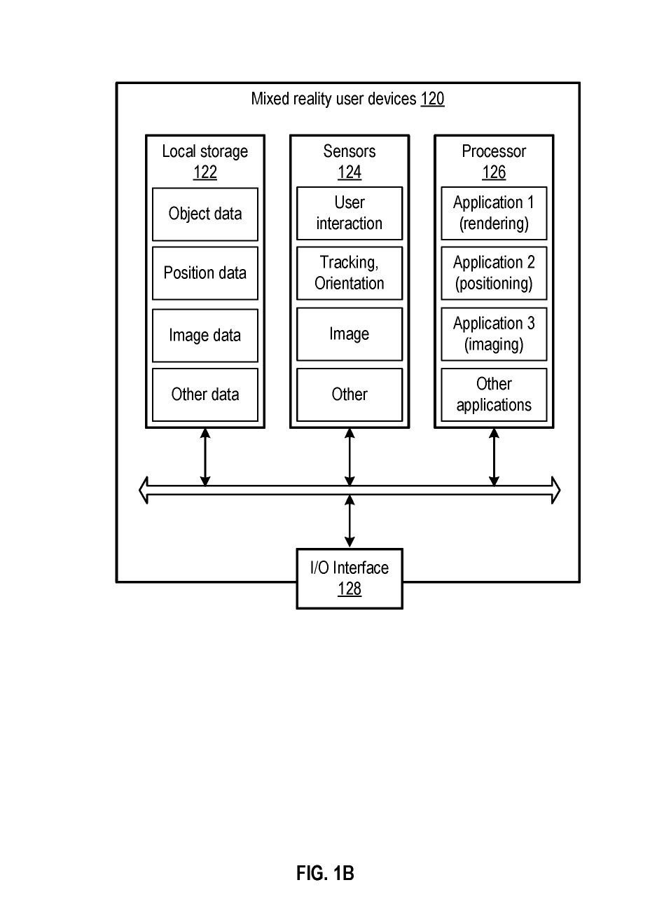

FIG. 1A is a functional block diagram of system for creating computer-generated virtual environments and providing the virtual environments as an immersive experience for VR, AR and/or MR users. Embodiments of the system depicted in FIG. 1A include a system on which a VR device can emulate user experience of an AR device. The system includes a mixed reality platform 110 that is communicatively coupled to any number of mixed reality user devices 120 such that data can be transferred between them as required for implementing the functionality described in this disclosure. General functional details about the platform 110 and the user devices 120 are discussed below before particular functions involving the platform 110 and the user devices 120 are discussed.

As shown in FIG. 1A, the platform 110 includes different architectural features, including a content manager 111, a content creator 113, a collaboration manager 115, and an input/output (I/O) interface 119. The content creator 113 creates a virtual environment, and also creates visual representations of things as virtual content (e.g., virtual objects, avatars, video, images, text, audio, or other presentable data) that can be displayed in a virtual environment depending on a user's point of view. Raw data may be received from any source, and then converted to virtual representations of that data (i.e., virtual content). Different versions of virtual content may also be created and modified using the content creator 113. The content manager 111 stores content created by the content creator 113, stores rules associated with the content, and also stores user information (e.g., permissions, device type, or other information). The collaboration manager 115 provides portions of a virtual environment and virtual content to each of the user devices 120 based on conditions, rules, poses (e.g., positions and orientations) of users in a virtual environment, interactions of users with virtual content, and other information. The I/O interface 119 provides secure transmissions between the platform 110 and each of the user devices 120.

FIG. 1B is a functional block diagram of user device for use with the system of FIG. 1. Each of the user devices 120 include different architectural features, and may include the features shown in FIG. 1B, including a local storage 122, sensors 124, processor(s) 126, and an input/output interface 128. The local storage 122 stores content received from the platform 110, and information collected by the sensors 124. The processor 126 runs different applications needed to display any virtual content or virtual environment to a user operating a user device. Such applications include rendering, tracking, positioning, 2D and 3D imaging, and other functions. The I/O interface 128 from each user device 120 manages transmissions between that user device 120 and the platform 110. The sensors 124 may include inertial sensors that sense movement and orientation (e.g., gyros, accelerometers and others), optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of user devices 120 include head-mounted displays, AR glasses, smart phones and other computing devices capable of displaying virtual content, and other suitable devices. By way of example, AR devices may include glasses, goggles, a smart phone, or other computing devices capable of projecting virtual content on a display of the device so the virtual content appears to be located in a physical space that is in view of a user.

Some of the sensors 124 (e.g., inertial, optical, and location sensors) are used to track the pose (e.g., position and orientation) of a user in virtual environments and physical environments. Tracking of user position and orientation (e.g., of a user head or eyes) is commonly used to determine fields of view, and each field of view is used to determine what virtual content is to be rendered using the processor 126 for presentation to the user on a display of a user device. Rendering can refer to performing the calculations necessary to assimilate a virtual scene for a given virtual environment. The output of the rendering can be a collection of scene data which includes geometry, viewpoint, texture, lighting, and shading information. The scene data is used to generate a pixelated version to display on 3D capable user device. In some examples, the rendering can also generate a photorealistic or non-photorealistic image from a 2D or 3D model. Tracking the positions and orientations of the user or any user input device (e.g., a handheld device) may also be used to determine interactions with virtual content. In some embodiments, an interaction with virtual content (e.g., a virtual object) includes a modification (e.g., change color or other) to the virtual content that is permitted after a tracked position of the user or user input device intersects with a point of the virtual content in a geospatial map of a virtual environment, and after a user-initiated command is provided to make the desired modification. Positions in a physical environment may be tracked in different ways, including positioning using Global Navigation Satellite Systems (GNSS), Bluetooth, WiFi, an altimeter, or any other known way to estimate the position of a thing (e.g., a user) in a physical environment.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual content among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images.

Examples of the user devices 120 include VR, AR, MR and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

The methods or processes outlined and described herein and particularly those that follow below, can be performed by one or more processors of the platform 110 either alone or in connection or cooperation with the user device(s) 120. The processes can also be performed using distributed or cloud-based computing.

### Generating Visual Representations of a Virtual Object for Display by User Devices

This disclosure is related to rendering or pre-rendering virtual content on the platform 110 (e.g., a server) for display on a user device 120. The system (e.g., the platform 110 in conjunction with the user device 120) can determine the direction a user and/or associated user device is/are moving so that images displayed via the respective AR/VR/MR device can also be pre-rendered on the server. This can reduce processing requirements at the user device. For example, a user device having limited processing power may be participating in a high-resolution virtual collaboration session. Accordingly, the user device may need to perform complicated calculations on large virtual objects to determine which portion of the object to display as the user moves about the (virtual) space. Systems and methods disclosed herein allow the user device to offload that complexity onto a server (e.g., the platform 110). While some servers have few limitations on processing power, network connections can impose certain speed limitations on how fast the server can calculate the rendered image and then transmit associated data back to the user device. Processing power limitations on the user device on the other hand may limit the ability to quickly render new images so that the associated operator or user wearing the AR/VR/MR device does not experience video delayed from actual or virtual motion. This can lead to negative user experience and even motion sickness, caused by even the slightest jitter in the virtual environment or lag between motion and visual display adjustments.

In some examples, the platform 110 can perform certain complicated calculations to produce (e.g., render) the scene data (geometry, viewpoint, texture, lighting and shading). The platform can then use the resulting scene data to produce a 2D image/video and send that to the device for display.

The systems and methods disclosed herein allow platform 110 to “guess” or otherwise estimate which direction and to where the user might be moving next and pre-calculate or render virtual content before arrival at the user device. For example, the server can provide a relatively constant stream of (rendered) images (image data) to the user device. The user device can then provide motion information back to the server related to where the user/user device actually moved. The server can then guess (e.g., estimate) again where the user will move next and pre-render the virtual object information (images) and transmit the data the user device 120.

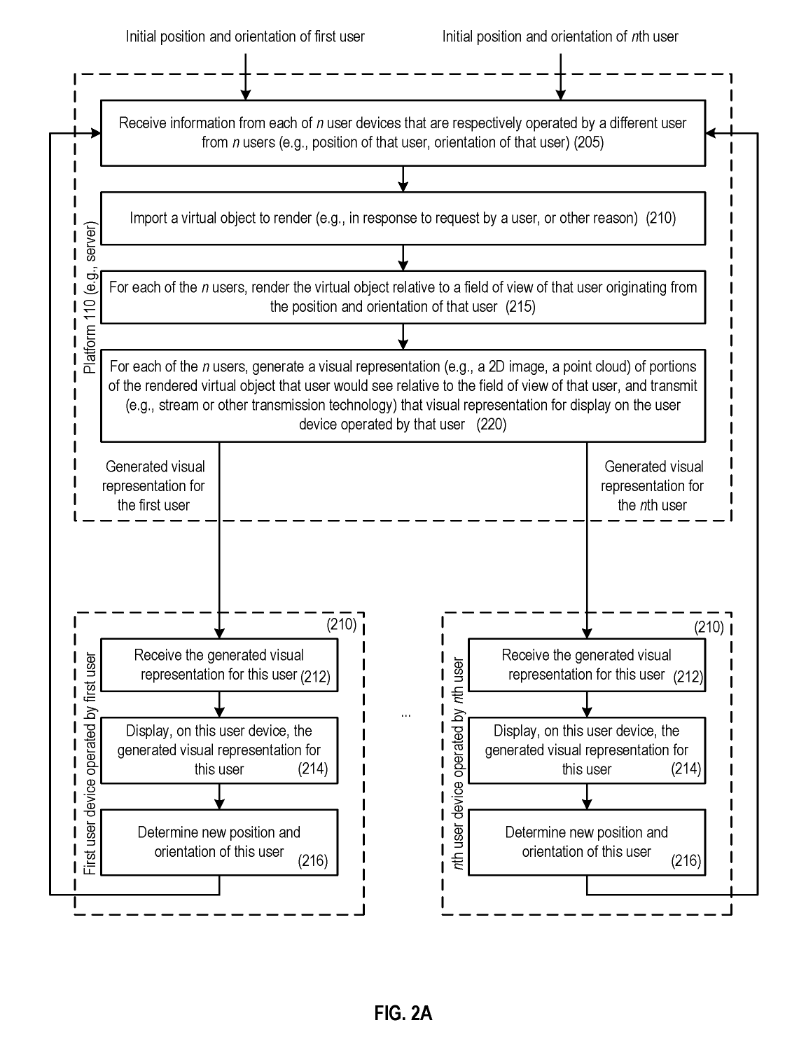

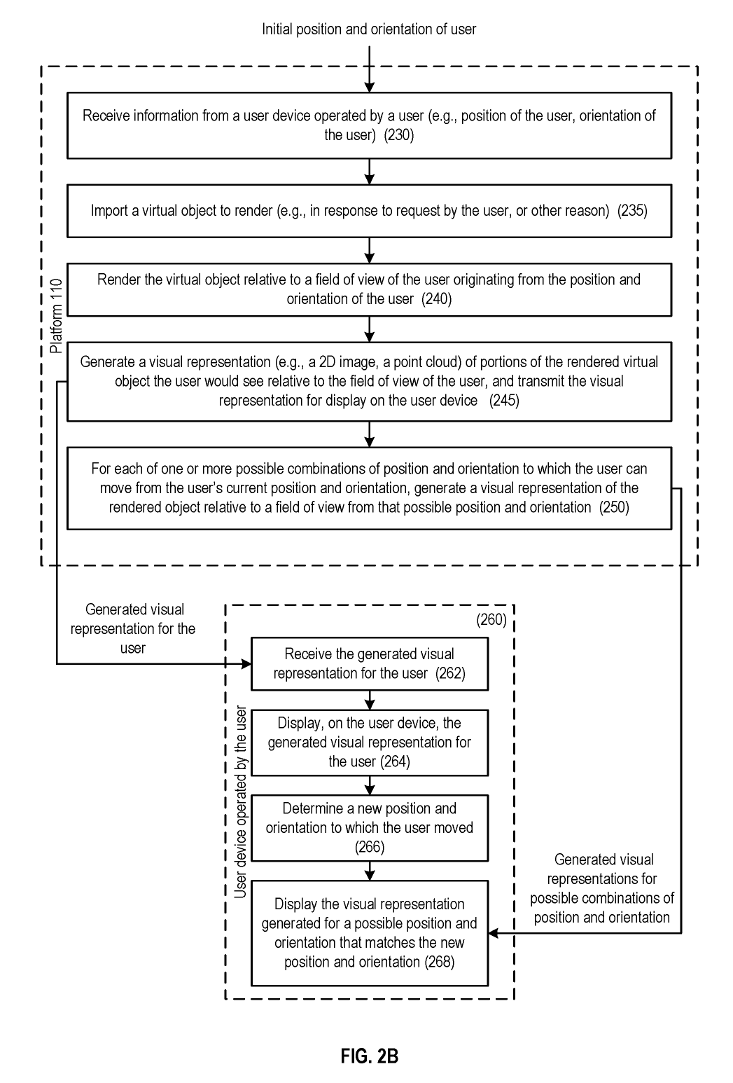

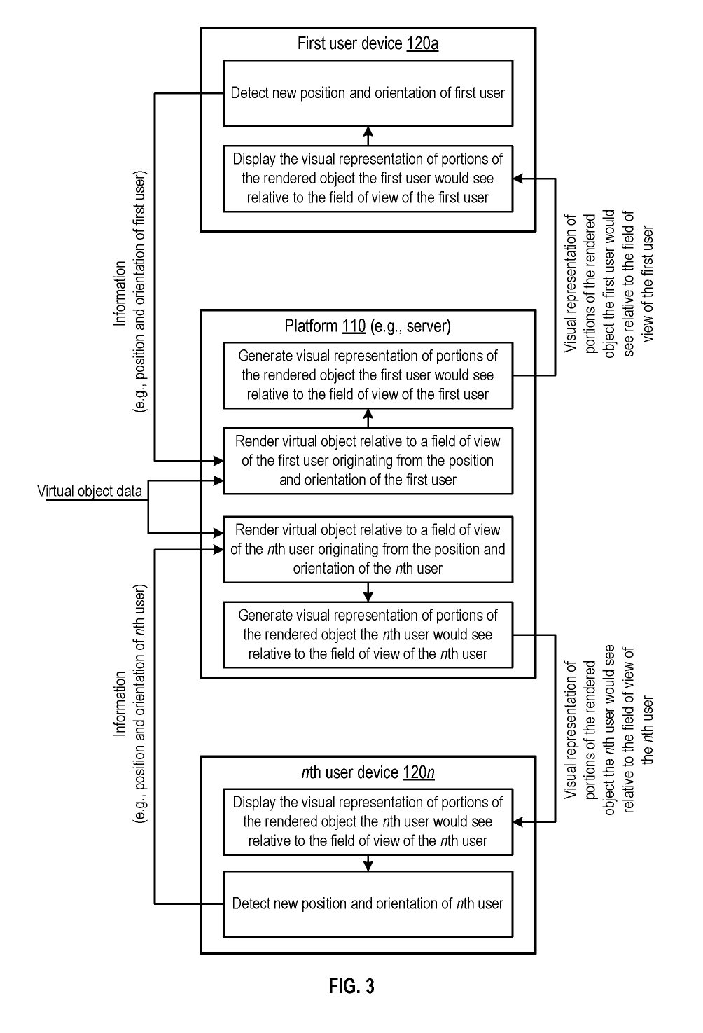

FIG. 2A is a flowchart of an embodiment of a process for generating visual representations of a virtual object for display by user devices. The method of FIG. 2A can be performed by the platform 110 in conjunction with the user device 120 to generate visual representations of a virtual object (e.g., a three-dimensional virtual object). Different visual representations can then be transmitted to different user devices 120 for display of those visual representations by the user devices. In some examples, the visual representations can include two dimensional representations of a three-dimensional virtual object. The process of FIG. 2A is performed instead of transmitting the virtual object to the user devices, and using each of the user devices to locally render the virtual object on that device. At block 205, the server (e.g., the platform 110) can receive information from each of n user devices 120 that are respectively operated by a different user from n users (e.g., position of that user, orientation of that user). Such information can relate to the field of view (FOV) of each of the n user devices 120. The FOV information can then be based on the position and orientation of each of the n user devices. At block 210, the server can import a virtual object to render (e.g., in response to a request by a user, a predictive process at the server based on user action, or other reason). In some examples, the platform 110 can store virtual content and object related to the associated virtual environment being represented at the user device 120. At block 215, the server can, for each of the n users, render the virtual object relative to a field of view of that user originating from the position and orientation of that user. At block 220, the server can, for each of the n users, generate a visual representation (e.g., a 2D image, a point cloud) of portions of the rendered object that user would see relative to the field of view of that user, and transmit (e.g., stream or using another transmission technology) that visual representation for display on the user device that is operated by that user. The steps of FIG. 2A further include performing the steps of block 210 at each of the n user devices 120. For example, at block 212, each user device can receive the generated visual representation for that user. At block 214, each user device 120 can display, on that user device, the generated visual representation for that user. At block 216, each user device can further determine a new position and orientation of that user. The substeps of block(s) 210 can be performed for each user device 120 of a plurality of user devices 120. The steps of FIG. 2A are repeated for the new positions and orientations of that user or user device 120. By way of example, FIG. 3 illustrates one implementation of FIG. 2A.

FIG. 2B is a flowchart of another embodiment of a process for generating visual representations of a virtual object for display by user devices. The method of FIG. 2A can be performed by the platform 110 in conjunction with the user device 120. In some examples, the server can generate visual representations of a virtual object from possible positions and orientations to which a user may move, and transmit the visual representations to the user device 120 operated by that user for later use by the user device depending on where the user actually moves at a later time.

At block 230 the server can receive information from a user device operated by a user (e.g., position and orientation of the user).

At block 235, the server can import a virtual object to render (e.g., in response to a request by the user, or other reason).

At block 240, the server can render the virtual object relative to a field of view of the user originating from the position and orientation of the user.

At block 245, the server can generate a visual representation (e.g., a 2D image, a point cloud) of portions of the rendered object the user would see relative to the field of view of the user, and transmit the visual representation for display on the user device.

At block 250, for each of one or more possible combinations of position and orientation to which the user can move from the user's current position and orientation, the server can generate a visual representation of the rendered object relative to a field of view originating from that possible combination of position and orientation.

The method of FIG. 2B can further include using the user device that is operated by the user to perform the steps of block 260. At block 262, the user device can receive the generated visual representation for the user. At block 264, the user device can display the generated visual representation for that user. At block 266, the user device can then determine a new position and orientation to which the user moved. At block 268, the user device can display the visual representation generated for a possible combination of position and orientation that matches the new position and orientation. The steps of FIG. 2B may be performed for different users, and may be repeated for additional positions and orientations of the user or each user.

The previously described methods provide visual representations (e.g., a 2D image, a point cloud) of virtual objects (e.g., three-dimensional virtual objects) to VR, AR and/or MR user devices instead of rendering the virtual objects using the VR, AR and/or MR user devices. Each visual representation may be of different quality, including a level of visual quality (e.g., resolution, detail, etc.) that matches the quality of a rendered version of the virtual object. The visual representations may be generated by capturing an image of the rendered object with a virtual camera from the position and orientation of that user, or by using a different approach. The visual representation may be presented to users of the VR, AR and/or MR user devices instead of a rendered version of the virtual object. The visual representation may be presented to users of the VR, AR and/or MR user devices in addition to other visual representations of other virtual objects, or in addition to rendered versions of other virtual objects. Each visual representation may be generated based on a rendered version of a virtual object that is rendered by a processor (e.g., a server) that is remote from each of the VR, AR and/or MR user devices, and that has greater processing capability than each of the VR, AR and/or MR user devices.

Use of the visual representation offers several advantages, including: (i) reduced bandwidth use between a server and each of the VR, AR and/or MR user devices (e.g., where transmission of the visual representation uses less data than transmission of the three-dimensional virtual object); (ii) ability to transmit image data of a virtual object to a user device above a minimum threshold speed that is needed to prevent an adverse user experience (e.g., to prevent the user from feeling sick when viewing delayed updates to changing image data); (iii) ability to display high-quality visual representations of three-dimensional virtual objects on devices with limited processing capability when that limited processing capability would prohibit rendering the three-dimensional virtual objects and displaying a rendered version of the three-dimensional virtual objects; (iv) elimination of expensive and bulky processing hardware in the VR, AR and/or MR user devices since less processing capability is needed to display the visual representation compared to the three- dimensional virtual object (which reduces weight, size and battery usage of VR, AR and/or MR user devices); (v) increased security by only transmitting images of certain portions of a virtual object that are in view of a user while not transmitting other portions (e.g., sensitive or confidential portions) of the virtual object (e.g., components inside the virtual object) that would otherwise be transmitted if the virtual object were provided to the VR, AR and/or MR user devices; and (vi) ability to display the same or similar visual representations of virtual objects on different VR, AR or MR user devices when the same or similar virtual object cannot be displayed on each of those different VR, AR or MR user devices. Each of these advantages are technical solutions to technical problems (e.g., data transmission, processing limitations, security, reduction of cost, reduction of battery usage, improved user experience, increased consumer use of smaller and/or lighter devices, etc.).

### Other Aspects

Each method of this disclosure can be used with virtual reality (VR), augmented reality (AR), and/or mixed reality (MR) technologies. Virtual environments and virtual content may be presented using VR technologies, AR technologies, and/or MR technologies.

Methods of this disclosure may be implemented by hardware, firmware or software.

One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120) or otherwise known in the art. One or more machines that are configured to perform the methods or operations comprising the steps of any methods described herein are contemplated.

Systems that include one or more machines and the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

What is claimed is:

1. A method for operating a virtual environment provided by a mixed reality platform, the method comprising:
receiving, at the platform, first position and orientation information from a first user device based on a first position and orientation of the first user device;
importing, at the platform, data related to a first virtual object from the virtual environment based on the first position and orientation information;
rendering the first virtual object as a rendered object relative to the first position and orientation;
generating a two dimensional representation of the rendered object;
transmitting the two dimensional representation to the first user device; and
causing a user device to display the generated visual representation.

2. The method of claim 1 further comprising receiving second position and orientation information from the first user device indicating a second position and orientation of the first user device.

3. The method of claim 2 further comprising:
rendering the first virtual object relative to the second position and orientation;
generating a second two dimensional representation of the rendered object based on the second position and orientation; and
transmitting the second two dimensional representation to the first user device.

4. The method of claim 1 further comprising generating a visual representation of the rendered object relative to a new field of view from each of one or more possible combinations of position and orientation to which the user can move from the first position and orientation. (250)

5. The method of claim 4, further comprising:
transmitting visual representations associated with the one or more possible combinations of position and orientation; and
causing the user device to display the visual representations generated for a possible position and orientation that matches a second position and orientation different from the first position and orientation. (268)

6. The method of claim 1, wherein the generating includes generating the two dimensional representation of portions of the rendered virtual object that user would see relative to a field of view of that user.

7. The method of claim 1, wherein the two dimensional representation of the rendered object comprises a point cloud or a two dimensional image of the rendered object.

8. A non-transitory computer-readable medium for operating a virtual environment provided by a mixed reality platform, comprising instructions that when executed by one or more processors, cause the one or more processors to:
receive first position and orientation information from a first user device based on a first position and orientation of the first user device;
import data related to a first virtual object from the virtual environment based on the first position and orientation information;
render the first virtual object as a rendered object relative to the first position and orientation;
generate a two dimensional representation of the rendered object;
transmit the two dimensional representation to the first user device; and
cause a user device to display the generated visual representation.

9. The non-transitory computer-readable medium of claim 8 wherein the instructions further cause the one or more processors to receive second position and orientation information from the first user device indicating a second position and orientation of the first user device.

10. The non-transitory computer-readable medium of claim 9 further cause the one or more processors to:
render the first virtual object relative to the second position and orientation;
generate a second two dimensional representation of the rendered object based on the second position and orientation; and
transmit the second two dimensional representation to the first user device.

11. The non-transitory computer-readable medium of claim 8 further cause the one or more processors to generate a visual representation of the rendered object relative to a new field of view from each of one or more possible combinations of position and orientation to which the user can move from the first position and orientation. (250)

12. The non-transitory computer-readable medium of claim 11, further cause the one or more processors to:
transmit visual representations associated with the one or more possible combinations of position and orientation; and
cause the user device to display the visual representations generated for a possible position and orientation that matches a second position and orientation different from the first position and orientation. (268)

13. The non-transitory computer-readable medium of claim 8, wherein the generating includes generating the two dimensional representation of portions of the rendered virtual object that user would see relative to a field of view of that user.

14. The non-transitory computer-readable medium of claim 8, wherein the two dimensional representation of the rendered object comprises a point cloud or a two dimensional image of the rendered object.
